(19) United States
(12) Patent Application Publication
(10) Pub. No.: US 2010/0101335 A1
(43) Pub. Date: Apr. 29, 2010

(54) STRAIN SENSORS

(76) Inventors: Mark Volanthen, Southampton (GB); Roger Caesley, Southamton (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/608,341

(22) Filed: Oct. 29, 2009

(30) Foreign Application Priority Data
Oct. 29, 2008 (GB) 0819777.4

(51) Int. Cl. G01L 1/22; G01L 1/24

(52) U.S. Cl. 73/862.045; 73/800

(57) ABSTRACT

A method of monitoring strain on a helicopter rotor blade that has several structural components comprises locating at least three strain sensors 2a, 2b, 2c on one of the structural components of the rotor blade, the positions of the strain sensors defining a plane transverse to the longitudinal direction of the rotor blade and resolving strain signals from the three strain sensors into strain measurements in two orthogonal directions.

### FIELD OF THE INVENTION

This invention relates to a method of monitoring strain on a helicopter rotor blade.

### BACKGROUND TO THE INVENTION

Helicopter rotor blades are typically constructed of glass-reinforced plastics (GRP) on a sub-structure, which may be formed of wood, glass fibre, carbon fibre, foam or other materials. Graphite fibre in epoxy resin is also used. The plastics resin can be injected into a mould containing the sub-structure to form the outer surface of the blade. The blade may also be built up as a series of layers of fibre material and resin. In some cases, the fibre material is pre-impregnated with resin. A typical helicopter rotor blade may have a length of between 5 and 10 metres or more.

Optical fibre strain sensors are known and WO 2004/056017 discloses a method of interrogating multiple fibre Bragg grating strain sensors along a single fibre. In the system of WO 2004/056017, Bragg gratings are defined in the optical fibre at spaced locations along the optical fibre. When the optical fibre is put under strain, the relative spacing of the planes of each Bragg grating changes and thus the resonant optical wavelength of the grating changes. By determining the resonant wavelength of each grating, a strain measurement can be derived for the location of each grating along the fibre. Optical strain sensors operating on the principle of back scattering which do not require discrete gratings along the fibre are also known.

Optical fibres are delicate components that require very accurate alignment to function correctly. It is therefore desirable to minimise the potential opportunities for damage to the optical fibres during installation in a helicopter rotor blade and any subsequent steps of the blade manufacturing process. The present invention, at least in its preferred embodiments, seeks to address this issue.

### SUMMARY OF THE INVENTION

According to the present invention, there is provided a method of monitoring strain on a helicopter rotor blade, the blade having a plurality of structural components. The method comprises locating at least three strain sensors on one of the structural components of the rotor blade, the positions of the strain sensors defining a plane transverse to the longitudinal direction of the rotor blade and resolving strain signals from the three strain sensors into strain measurements in two orthogonal directions. The strain signals may be bending strains or bending loads in two orthogonal directions.

Thus, according to the present invention, the three strain sensors are located on only one of the structural members of the rotor blade. In this way, the sensors can be installed in the one component during manufacture even before the various components are assembled into a helicopter rotor. This significantly simplifies the integration of strain sensors into the manufacturing process for helicopter rotors. Thus, the strain sensors may be located on the structural components before the structural component is assembled into the helicopter rotor blade.

The structural components of the helicopter rotor blade may include at least two outer shell members, which together form the outer surface of the rotor blade. The method may include locating the strain sensors on one of the outer shell members. For example, the strain sensors may be located on the internal surface of the outer shell member.

The structural components of the helicopter rotor blade may include at least one structural beam to which at least one shell member which forms the outer surface of the rotor blade is connected in the assembled helicopter rotor blade. The method may include locating the strain sensors on the structural beam. The strain sensors may be located, for example, on an inside or an outside surface of the structural beam. The structural beam may be, for example, a box beam.

The helicopter rotor blade may comprise structural components that are each shorter than the complete length of the assembled helicopter rotor blade but which together are assembled into the complete blade.

The method may comprise locating a connector for the output of the three strain sensors on the same structural component of the rotor blade as the three strain sensors.

### BRIEF DESCRIPTION OF THE DRAWINGS

Embodiments of the invention will now be described by way of example only and with reference to the accompanying drawings, in which:

FIG. 1 shows the positioning of strain sensors within a helicopter rotor blade according to a first embodiment of the invention;

FIG. 2 shows the positioning of strain sensors within a helicopter rotor blade according to a second embodiment of the invention; and

FIG. 3 shows the positioning of strain sensors within a helicopter rotor blade according to a third embodiment of the invention.

### DETAILED DESCRIPTION OF EMBODIMENTS

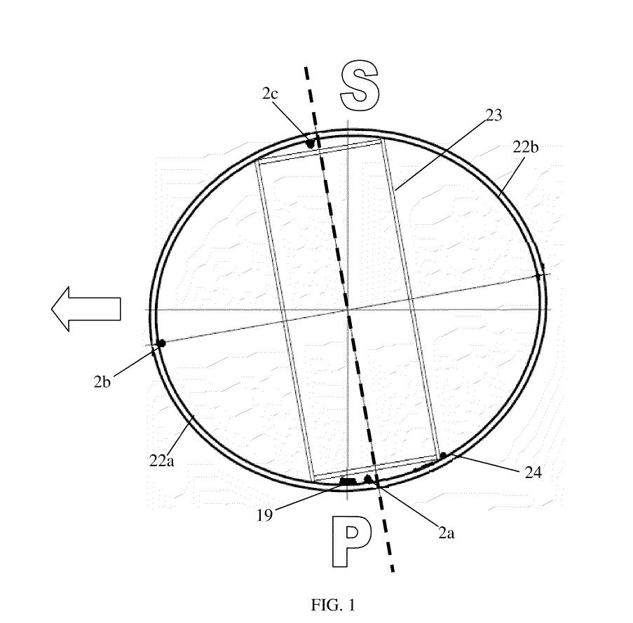

FIG. 1 shows the positioning of strain sensors 2a, 2b, 2c in a typical helicopter rotor blade 21. The view in FIG. 1 is a cross section of the base of the rotor blade 21 viewed from the hub of the helicopter rotor towards the tip of the rotor blade 21. The direction of travel of the rotor blade is indicated by the large arrow and the suction side of the blade aerofoil is indicated by the large letter S and the pressure side of the blade aerofoil is indicated by the large letter P. The rotor blade 21 is constructed as a surface shell formed in two halves 22a, 22b that are mounted about a structural box beam 23. The dividing line between the two halves 22a, 22b of the surface shell is indicated by the heavy dashed line in FIG. 1. The sensors are mounted to the internal surface of one half of the shell 22a at the centre of the shell half 22a and at the edges of the shell half 22a. In this way, the sensors 2a, 2b, 2c are mounted to single structural component of the rotor blade 21, so that it is not necessary for the connections between individual sensors to cross between components of the rotor blade.

The sensors 2a, 2b, 2c take the form of fibre Bragg gratings formed in an optical fibre that forms the connection between the gratings. The optical fibre is connected, in use, to an instrument that supplies optical pulses to the optical fibre and evaluates the reflected light from the gratings as described in WO 2004/056017, for example.

As shown in FIG. 1, the first sensor 2a is located on the pressure side of the rotor blade 21. The third sensor 2c is located on the suction side of the rotor blade 21. Thus, the differential strain measurements from this pair of sensors can be used to determine bending moments on the rotor blade 21 due to forces normal to the plane of rotation of the rotor blade.

The second sensor 2b is located on the leading edge of the rotor blade 21. Thus, the differential strain measurements from the second sensor 2b and the sum of the strain measurements from the first and the third sensors 2a, 2c can be used to determine bending moments on the rotor blade 21 due to forces in the plane of rotation of the rotor blade.

A connector box 19 is mounted to the inner surface of the rotor blade 21 at a suitable location in the same shell half 22a as the sensors 2a, 2b, 2c and provides the connection between the optical fibre that contains the sensors 2a, 2b, 2c and the external sensing instrument. The rotor blade 21 includes a lightning conductor 24 and it will be seen that the sensors are arranged such that there is no connection that crosses the lightning conductor 24.

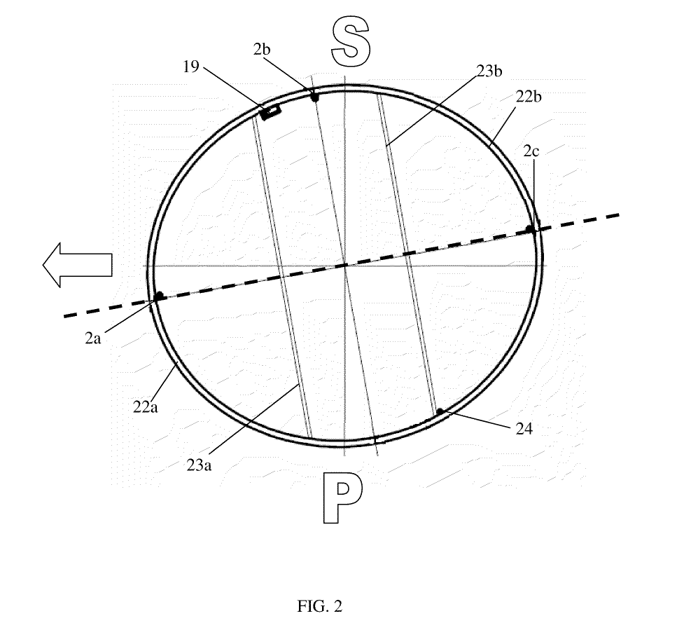

FIG. 2 shows a second embodiment of the invention in which the blade shell halves 22a, 22b are connected by shear webs 23a, 23b, rather than the central beam 23 of FIG. 1. In this case, the blade shell halves 22a, 22b are at right angles to the orientation in FIG. 1. In the embodiment of FIG. 2, the first sensor 2a is located on the leading edge of the rotor blade 21. The third sensor 2c is located on the trailing edge of the rotor blade 21. Thus, the differential strain measurements from this pair of sensors can be used to determine bending moments on the rotor blade 21 due to forces in the plane of rotation of the rotor blade 21.

In this embodiment, the second sensor 2b is located on the suction side of the rotor blade 21. Thus, the differential strain measurements from the second sensor 2b and the sum of the strain measurements from the first and the third sensors 2a, 2c can be used to determine bending moments on the rotor blade 21 due to forces normal to the plane of rotation of the rotor blade.

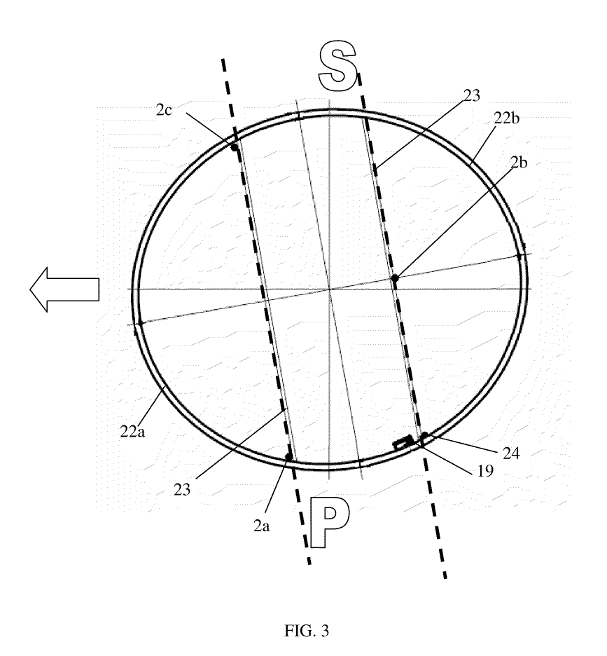

FIG. 3 shows a third embodiment of the invention in which the sensors 2a, 2b, 2c are mounted to the central beam 23 of the rotor blade 21, which itself forms a portion of the outer surface of the rotor blade 21. The interface between the central beam 23 and the two parts of the blade shell 22a, 22b is indicated by dashed lines in FIG. 3. In the embodiment of FIG. 3, the first sensor 2a is located towards the pressure side of the rotor blade 21. The third sensor 2c is located towards the suction side of the rotor blade 21. Thus, the differential strain measurements from this pair of sensors can be used to determine bending moments on the rotor blade 21 due to forces normal to the plane of rotation of the rotor blade 21.

In this embodiment, the second sensor 2b is located towards the trailing edge of the rotor blade 21. Thus, the differential strain measurements from the second sensor 2b and the sum of the strain measurements from the first and the third sensors 2a, 2c can be used to determine bending moments on the rotor blade 21 due to forces in the plane of rotation of the rotor blade.

In summary, a method of monitoring strain on a helicopter rotor blade that has several structural components comprises locating at least three strain sensors 2a, 2b, 2c on one of the structural components of the rotor blade, the positions of the strain sensors defining a plane transverse to the longitudinal direction of the rotor blade and resolving strain signals from the three strain sensors into strain measurements in two orthogonal directions.

1. A method of monitoring strain on a helicopter rotor blade, the blade having a plurality of structural components, the method comprising:
locating at least three strain sensors on one of the structural components of the rotor blade, the positions of the strain sensors defining a plane transverse to the longitudinal direction of the rotor blade; and
resolving strain signals from the three strain sensors into strain measurements in two orthogonal directions.

2. A method as claimed in claim 1, wherein the strain sensors are located on the structural components before the structural component is assembled into the rotor blade.

3. A method as claimed in claim 1, wherein the structural components of the helicopter rotor blade include at least two outer shell members, which together form the outer surface of the rotor blade, and the method includes locating the strain sensors on one of the outer shell members.

4. A method as claimed in claim 1, wherein the structural components of the helicopter rotor blade include at least one structural beam to which at least one shell member which forms the outer surface of the rotor blade is connected in the assembled helicopter rotor blade, and the method includes locating the strain sensors on the structural beam.

5. A method as claimed in claim 1, wherein the method comprises locating a connector for the output of the three strain sensors on the same structural component of the rotor blade as the three strain sensors.
